(19) United States
(12) Patent Application Publication
(10) Pub. No.: US 2008/0101381 A1
(43) Pub. Date: May 1, 2008

(54) ADDRESS RESOLUTION PROTOCOL (ARP) CACHE MANAGEMENT METHODS AND DEVICES

(75) Inventors: Jing He Sun, Changhua Hsien (TW); Guan-Hua Tu, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/552,678

(22) Filed: Oct. 25, 2006

(51) Int. Cl. H04L 12/56

(52) U.S. Cl. 370/395.54

(57) ABSTRACT

An address resolution protocol (ARP) cache management method. An ARP cache comprises a plurality of ARP tables. Each ARP table comprises a plurality of updatable entries. The method comprises: receiving an ARP message; looking up the pluralities of ARP tables to find a message-matching entry; choosing an ARP table for storing new entries; creating a new entry to overwrite an existing entry in the chosen ARP table if no message-matching entry is found after looking up the ARP tables.

### BACKGROUND OF THE INVENTION

1. Field of the Invention

The present invention relates to computer communication techniques, and more particularly to address resolution protocol (ARP) cache management methods and devices.

2. Description of the Related Art

In order to transmit a datagram to a destination host through a local network, a sender host must retrieve at least a hardware address, such as a media access control (MAC) address, of the destination host, and fill the hardware address in a link layer frame carrying the datagram. FIG. 1 shows a link layer frame 100 with datagram 101 and header 102 comprising a next-hop's hardware address and a sender hardware address. The protocol address in the datagram 101, such as an Internet protocol (IP) address, is utilized to identify the destination host of the frame and utilized for determining a route thereof to the destination host. When the frame is sent from the sender host through a network, the next hop in the route is determined based on a routing table. To transmit the frame hop by hop, the next-hop's hardware address must be filled in the link layer header to identify the next hop of the frame. A hardware address in the link layer header enables a server to determine its frame destination.

Address resolution protocol (ARP) is utilized to obtain a hardware address (such as a MAC address) of a network node from its protocol address (such as an IP address). Generally, each network node has an ARP cache (a kind of memory) for storing and maintaining its own ARP table. The ARP table comprises a plurality of entries. Each entry comprises a mapping relationship between the protocol and hardware addresses corresponding to a specific network node. Table 1 illustrates an example of the ARP table:

TABLE 1

| Protocol address | Hardware address | |
|---|---|---|
| (IP address) | (MAC address) | Other information |
| 172.16.0.2 | 00.01.22.33.E3.98 | . . . |
| 172.16.0.35 | 00.01.45.86.23.8F | . . . |
| 172.16.0.254 | 00.01.02.35.63.7E | . . . |

When frame transmission is required, the sender host looks up its own ARP table first for resolving the next-hop's hardware address. If no matching entry is found in the ARP table of the sender host, an ARP request is broadcasted to retrieve an ARP reply from the destination host, the next hop. When the ARP reply is retrieved, a corresponding entry thereof is added to the ARP table of the sender host for further reference. Thus, ARP entries are cached in an ARP table for the address resolution process.

From the above description, we can understand that an ARP entry is added to an ARP table upon receipt of an ARP reply. However, an ARP entry may be added upon receipt of an unsolicited ARP message destined to the target host from any host in a network. Newly received unsolicited ARP message destined to the target host may result in an existing ARP entry being overwritten by a new entry corresponding to the ARP message regardless of the significance of these two entries. A frequently referenced entry may be overwritten by a useless entry. This may lower an ARP cache hit ratio. In a worst case scenario, the ARP entries may be flushed by malicious attacks. Devices with limited ARP table capacity are especially susceptible to malicious message attacks. Further, downgraded hit ratios may generate mass ARP requests and replies and reduce device and network performance. On the other hand, as a large ARP table capacity may increase the hit ratio of ARP entry queries, it may also consume time looking up the table.

### BRIEF SUMMARY OF THE INVENTION

A detailed description is given in the following embodiments with reference to the accompanying drawings.

An exemplary embodiment of an address resolution protocol (ARP) cache management method is implemented in a communication device with an ARP cache. The ARP cache comprises a plurality of ARP tables and each table comprises updatable entries. The method comprises: receiving an ARP message; looking up the pluralities of ARP tables to find a message-matching entry; choosing an ARP table for storing new entries; creating a new entry to overwrite an existing entry in the chosen ARP table if no message-matching entry is found after looking up the ARP tables.

An exemplary embodiment of a communication device capable of managing an address resolution protocol (ARP) cache. The ARP cache comprises a plurality of ARP tables and each table comprises updatable entries. The communication device further comprises a network interface unit and a processor. The network interface unit receives ARP messages or transmits frames to a target host. The processor creates a new entry to overwrite an existing entry in a chosen ARP table if necessary.

An exemplary embodiment of an address resolution protocol (ARP) cache management method for managing an ARP cache with updatable entries in a communication device comprises the following steps. An entry operation is performed on a first entry in the ARP cache in response to a frame-based communication request. The first entry is classified into one of a plurality of ARP tables in the ARP cache according to the entry operation and the frame-based communication.

An exemplary embodiment of a communication device capable of managing address resolution protocol (ARP) cache with updatable entries comprises a network interface unit and a processor. The network interface unit receives a request for frame-based communication. The processor performs an entry operation on a first entry in the ARP cache in response to the request and classifying the first entry into one of a plurality of ARP tables in the ARP cache according to the entry operation and the frame-based communication.

An exemplary embodiment of an address resolution protocol (ARP) cache management method is implemented in a communication device with an ARP cache. The ARP cache comprises at least a reserved and an unreserved ARP table, each comprising updatable entries. The method comprises the following steps. When the communication device receives an ARP message, it is determined if the ARP cache comprises a message-matching entry comprising a cache protocol address matching the sender protocol address included in the received ARP message. If not, and when the ARP message is destined to the communication device, a new entry is restricted to be created in an unreserved ARP table to respond to the ARP message.

An exemplary embodiment of an address resolution protocol (ARP) cache management method is implemented in a communication device with an ARP cache. The ARP cache comprises a reserved and an unreserved ARP table, each comprising updatable entries. The method comprises the following steps. When the communication device is to send a frame, the reserved ARP table is first searched to locate a transmission matching entry of the frame. The cache protocol address in the transmission matching entry matches the protocol address of a next hop of the frame. When no transmission matching entry exists in the reserved ARP table, the unreserved ARP table is then searched to locate a transmission matching entry. When no transmission matching entry exists in the ARP cache, a new entry is restricted to be created in the reserved ARP table.

An exemplary embodiment of an address resolution protocol (ARP) cache management method is implemented in a communication device with an ARP cache. The ARP cache comprises updatable entries. The method comprises the following steps. When the communication device receives an ARP message, it is determined if the ARP cache comprises a message-matching entry comprising a cache protocol address matching the sender protocol address included in the received ARP message. When the ARP cache has no such matching entry, and the ARP message is destined to the communication device, a new entry is created in ARP cache to respond the ARP message reception with the restriction that the number of created entries in response to ARP message reception is less than the total number of all the updatable entries of the ARP cache.

An exemplary embodiment of an address resolution protocol (ARP) cache management method is implemented in a communication device with an ARP cache. The ARP cache comprises updatable entries. The method comprises the following steps. New entries are created in ARP cache to respond ARP message reception when the condition of entry creation is satisfied. The number of created entries in response to ARP message reception is restricted to be less than the total number of all the updatable entries of the ARP cache.

### BRIEF DESCRIPTION OF THE DRAWINGS

The invention can be more fully understood by reading the subsequent detailed description and examples with references made to the accompanying drawings, wherein:

FIG. 1 is a schematic diagram of an example of a link layer frame;

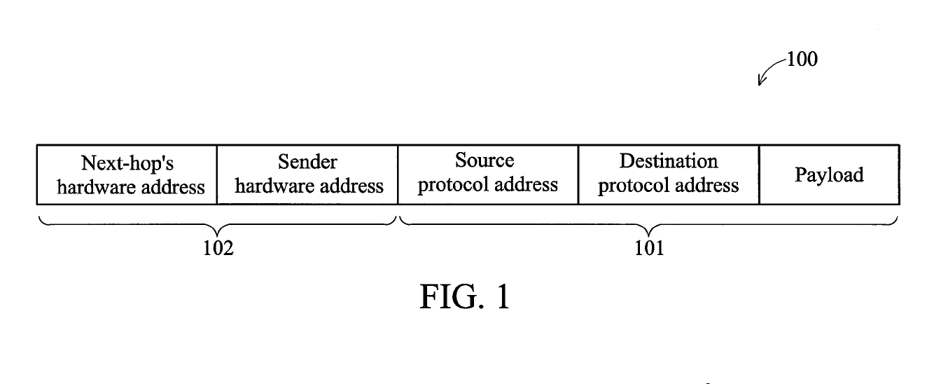

FIG. 2 is a block diagram of the configuration of an exemplary embodiment of a communication device and a network system;

FIG. 3 is a schematic diagram of an exemplary embodiment of an ARP cache;

FIG. 4 is a schematic diagram of a second exemplary embodiment of an ARP table allocation;

FIG. 5 is a schematic diagram of a third exemplary embodiment of an ARP table allocation;

FIG. 6 is a flowchart of an exemplary ARP cache operation for ARP message reception; and

FIG. 7 is a flowchart of an exemplary ARP cache operation for packet transmission.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

ARP cache management methods and devices are provided in the following with exemplary embodiments thereof organized as:

1. Hardware configuration

2. ARP cache configuration

3. ARP messages Reception

4. Frame transmission

5. Conclusion

### 1. HARDWARE CONFIGURATION

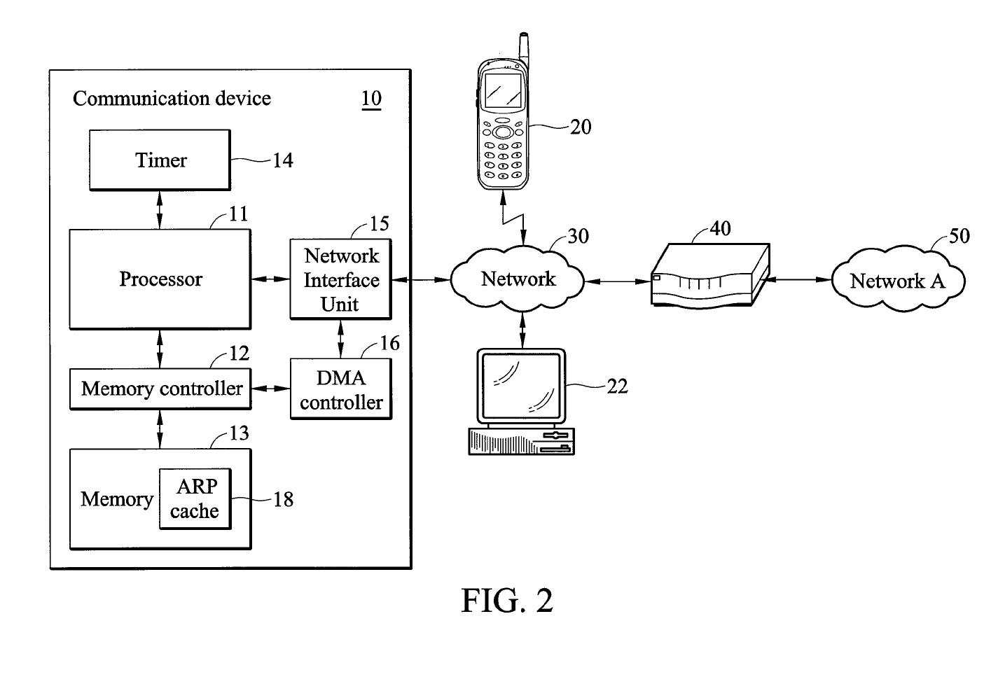

FIG. 2 shows a typical network system in which several devices are connected by various networks. Each of network 30 and network A 50 may comprise a local area network (LAN) or a wide area network (WAN), such as the Internet. The communication device 10 is connected to other communication devices, such as the mobile device 20 and computer 22, through network 30. Mobile device 20 may comprise a mobile phone, a personal digital assistant (PDA), a tablet personal computer (PC), or a similar portable device. The router 40, also connected to network 30, routes network data packets between network 30 and another network, network A 50. The communication device 10 comprises processor 11, memory controller 12, memory 13, timer 14, network interface unit 15, and DMA controller 16. Processor 11 controls the operation of the entire system as it fetches and executes software codes stored in memory 13. Memory controller 12 serves as the bridge between processor 11 and memory 13 to transfer data therebetween. ARP cache 18 may be stored in memory 13 and its content is maintained and updated according to the ARP management method described later. An ARP cache may be located in other memory units, such as an on-chip memory, an on-board memory, or storage devices, such as a flash memory, an electrically erasable programmable read-only memory (EEPROM) built on a motherboard or in NIU 15, or a hard disk. Timer 14 provides timing information to processor 11 so that processor 11 can obtain the time when certain events happen, such as when an ARP cache entry is added.

Network interface unit (NIU) 15, the communication unit of device 10, connects with network 30 via TCP/IP network protocol. Common NIUs include Ethernet network interface devices and wireless local area network (WLAN) devices which may be implemented in any wireless network, such as WLAN or IEEE 802.11 network. The connection with network 30 can be wire-lined or wireless, depending on the NIU technology employed. NIU 15 transfers and receives data packets to and from Network 30. Data packets outgoing to network 30 may be prepared and provided by processor 11, or preferably by DMA controller 16, which obtains packet data from memory 13 through memory controller 12 without intervention of processor 11.

When communication device 10 is going to send an ARP request to network 30, processor 11 composes the ARP request packet in memory 13, and then programs DMA controller 16 to transfer the packet through NIU 15 to network 30. In the opposite direction, when an ARP request packet is received from Network 30, the packet can go through NIU 15, DMA controller 16 and memory controller 12 to memory 13. Processor 1 may then access the packet data in memory 13 to perform necessary operations.

Communication device 10 capable of ARP cache management may comprise a cell phone, a personal digital assistant (PDA), a laptop or desktop computer, or other devices. Processor 11 maintains the ARP cache 18 in response to ARP requests and acknowledgements. Note that an ARP cache may be managed by other processors, such as memory controller 12, DMA controller 16, or a processor in NIU 15. In some embodiments of the communication device, any pair of components (such as processor 11, memory controller 12, memory 13, or DMA controller 16) may be integrated into a single chip.

### 2. ARP CACHE CONFIGURATION

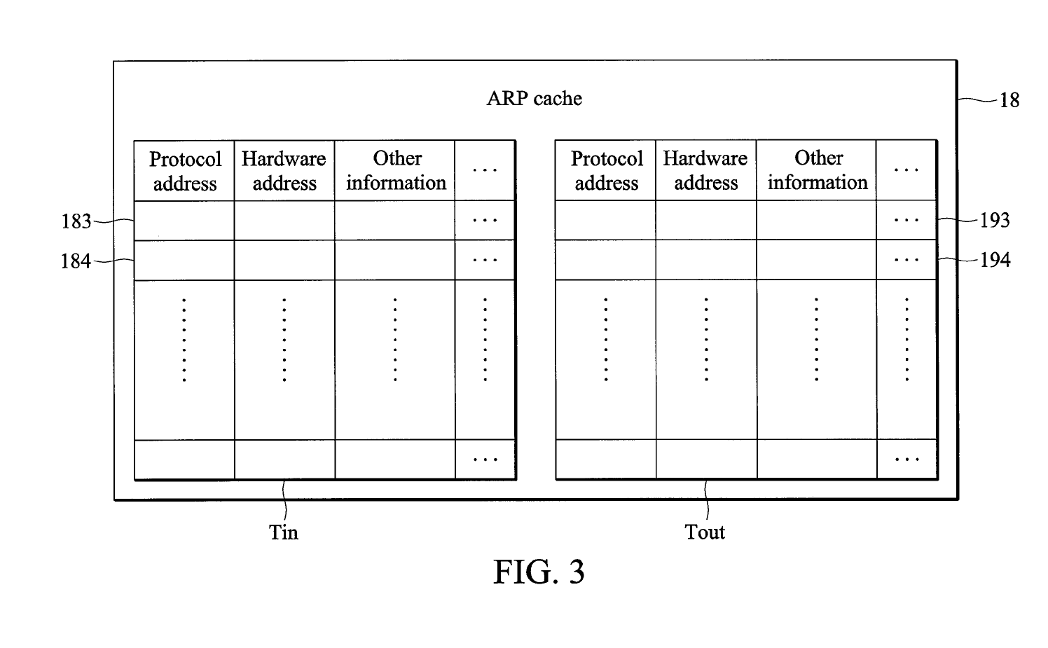

With reference to FIG. 3, the ARP cache 18 comprises a plurality of ARP tables Tᵢₙ and Tₒᵤₜ. Each ARP table comprises a plurality of entries (e.g. 183 and 184 in table Tᵢₙ and 193 and 194 in table Tₒᵤₜ). Please note that the size of each table can be different if required. For example, the size of table Tₒᵤₜ can be larger than that of table Tᵢₙ. Also note that the number of ARP tables is not taken to be a limitation. The entry in each ARP table comprises at least a protocol address field, a hardware address field, and other information fields. The protocol address field and the hardware address field store a protocol address and a hardware address associated with each other and typically owned by a network node (i.e. a device connected to a network). The other information field in an entry may be utilized to find a least useful entry in the ARP table. The other information field may store the latest reference time or the created time of the entry provided by timer 14 or, alternatively, the reference count of the entry. For example, assumed that there are three entries in the ARP table, the corresponding latest reference times of the three entries are respectively T1=one hour ago, T2=two hours ago, and T3=three hours ago, the corresponding generation times of the three entries are respectively T4=March 2006, T5=April 2004, and T6=January 2005, and the reference count of the three entries are respectively C1=five, C2=twelve, and C3=thirty. If the other information field stores the latest reference time of the entry, the least useful entry is determined to be the third entry whose latest reference time is T3. If the other information field stores the generation time of the entry, the least useful entry is determined to be the second entry whose generation time is T5. If the other information field stores the reference count of the entry, the least useful entry is determined to be the first entry whose reference count is equal to C1. Note that an entry may comprise both the latest reference time and the reference count which records the number of reference operations for the entry. In this situation, the least useful entry may be determined according to both of the latest reference time and the reference count. A detailed description of the functionality and operation of the ARP tables Tᵢₙ and Tₒᵤₜ is provided in the following.

The entries in the first table (Tᵢₙ) are restricted to those created in response to ARP message receipt, and the entries in the second table (Tₒᵤₜ) are restricted to those created in response to packet (or frame) transmission. In other words, entries created in response to ARP message receipt are stored and classified into Tᵢₙ and entries created in response to frame transmission are stored and classified into Tₒᵤₜ. Thus, communication device 10 classifies the updatable entries and prevents Tᵢₙ and Tₒᵤₜ from unconditional entry creation. Some entries (least useful entries) in one table may be removed or overwritten according to latest reference time, generation time, or the reference count. Some entries in one table may be further moved to another table according to the precedence of each table (e.g. from a table of lower precedence to another table of higher precedence) and the specific attribute (utilized to determine which entry belongs to which ARP table). Furthermore, different tables may be located in different areas of the ARP cache or discretely distributed with each entry thereof identified by an associated class ID. A detailed description of table allocation is provided in the following.

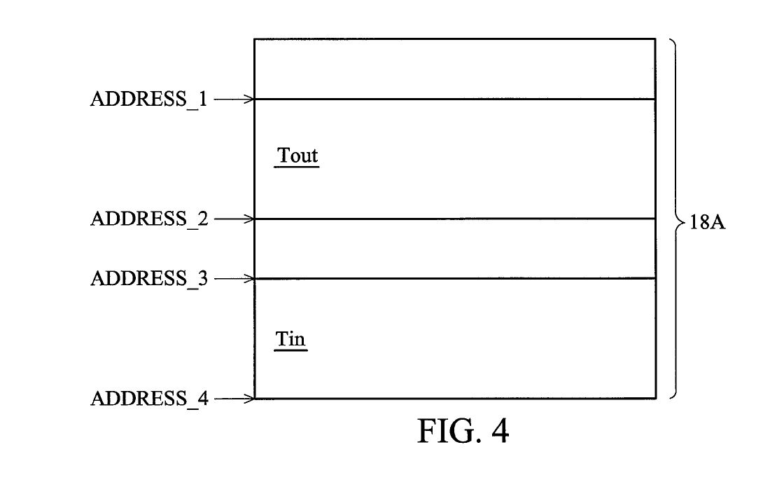

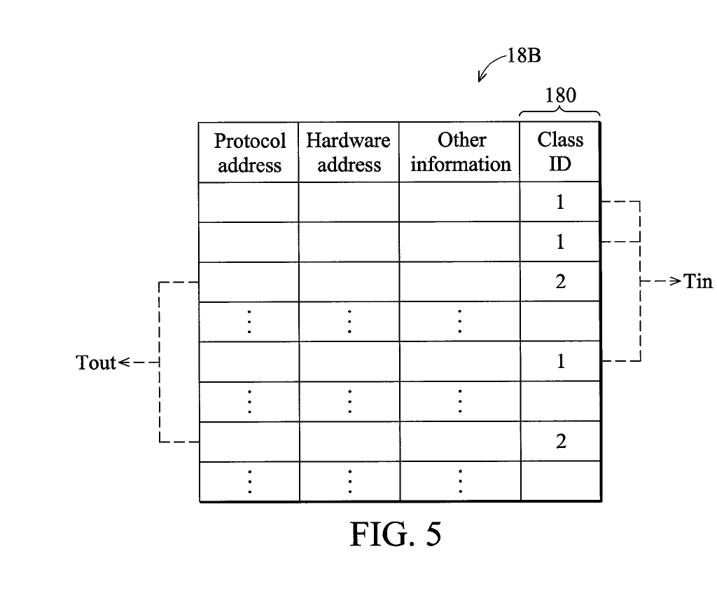

FIGS. 4 and 5 are examples of ARP caches with different table allocation. In FIG. 4, Tᵢₙ and Tₒᵤₜ are respectively located in different areas of the ARP cache 18A, for which two different ranges of addresses are allocated. Table Tₒᵤₜ locates from ADDRESS_1 to ADDRESS_2 in the ARP cache 18A while Table Tᵢₙ locates from ADDRESS_3 to ADDRESS_4 in the ARP cache 18A. In FIG. 5, whether one entry belongs to Tᵢₙ or Tₒᵤₜ is determined based on an attribute (such as a value in class ID field 180) associated with the entry. Entries with class ID “1” belong to table Tᵢₙ, and entries with class ID “2” belong to table Tₒᵤₜ. Note that the attribute and the ARP cache may be separated and stored anywhere in communication device 10. In some embodiments, ARP caches may be configured in other data structure, such as linked lists. A variable C (not shown) listed as other information in FIG. 5 may serve as a counter recording the number of entries in Tᵢₙ, and a variable S (not shown) may be preset as the upper limit of the variable C, thus limiting the number of entries in Tᵢₙ to be less than the total number of updatable entries in the ARP cache. For example, assumed that the variable S is set to be 5 and the variable C is 3. Since the variable C is not larger than the variable S, new entries can still be added to table Tᵢₙ. Once the variable C increments to 5, no more new entry can be added to table Tᵢₙ (the new entry can still overwrite an existing entry).

Tᵢₙ and Tₒᵤₜ may be respectively prioritized in that Tᵢₙ is first referenced in response to ARP message receipt prior to other tables in ARP cache 18, and Tₒᵤₜ is first referenced in response to frame transmission prior to other tables in ARP cache 18. Alternatively, Tₒᵤₜ may be respectively prioritized to be first referenced prior to other tables in ARP cache 18 in response to frame transmission and ARP message receipt.

The ARP cache management method performs an entry operation on an entry in the ARP cache in response to a request for frame-based communication and classifies the entry into one of a plurality of tables in the ARP cache according to the entry operation and the frame-based communication. The frame-based communication comprises ARP message receipt and frame transmission, and the frame-based communication request may be delivered by an application in communication device 10 or other devices coupled thereto. Details of the ARP cache management in the following are set forth with respect to ARP message receipt and frame transmission.

### 3. ARP MESSAGES RECEPTION

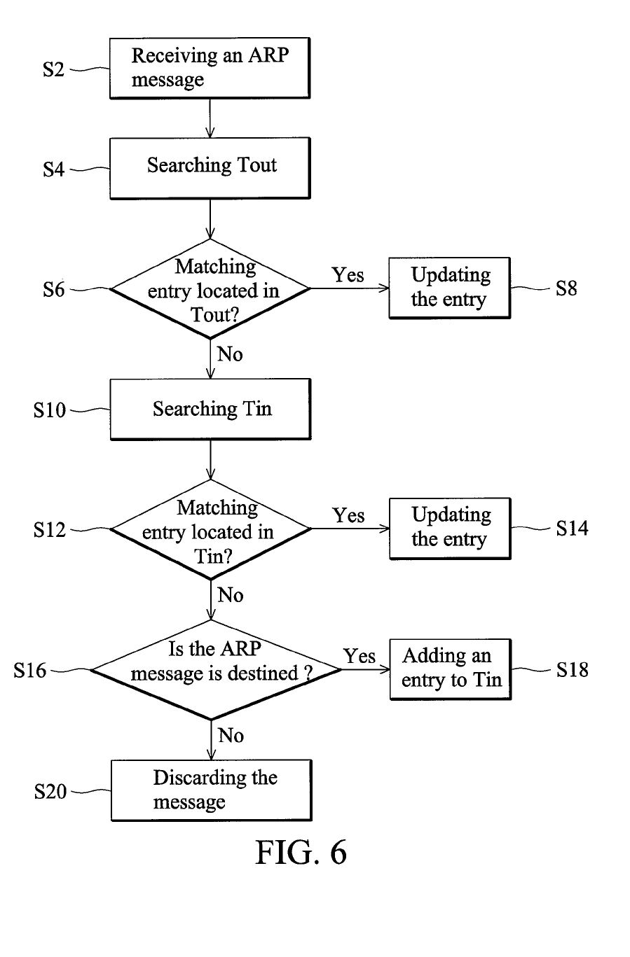

Communication device 10 performs ARP cache operations when receiving an ARP message. With reference to FIG. 6, when NIU 15 receives an ARP message (step S2), processor 11 first searches table Tₒᵤₜ for a matching entry of the ARP message (step S4), which comprises a protocol address matching the sender protocol address included in the received ARP message. In other words, the matching entry is an entry whose protocol address is the same as that of the ARP message. Processor 11 determines if such a matching entry of the ARP message is located in table Tₒᵤₜ (step S6). If so, processor 11 updates the matching entry in Tₒᵤₜ by utilizing the ARP message (step S8). Processor 11 may update the matching entry by filling a hardware address field of the matching entry with the sender hardware address included in the ARP message.

If Tₒᵤₜ does not have a matching entry (no in step S6), processor 11 searches Tᵢₙ for an entry matching the ARP message (step S10) and determines if the matching entry is located in table Tᵢₙ (step S12). If so, processor 11 updates the matching entry in table Tᵢₙ utilizing the ARP message (step S14). Similarly, processor 11 may update the matching entry by filling a hardware address field of the matching entry with the sender hardware address included in the ARP message. Note that communication device 10 does not change the classification of the matching entry.

If table Tᵢₙ does not have such a matching entry, processor 11 determines if the ARP message is destined to communication device 10 (step S116). When ARP cache 18 has no such matching entry, and the ARP message is destined to communication device 10, processor 11 creates a new entry and restricts the new entry to be created as a member of table Tᵢₙ to respond to the ARP message (step S18). Processor 11 may fill a protocol address field and a hardware address field of the new entry with the sender protocol address and the sender hardware address included in the ARP message. When table Tᵢₙ is full, the least useful entries therein may be removed or overwritten by the new entry. The number of entries of table Tᵢₙ is limited to less than the total number of all the updatable entries of the ARP cache, thus to prevent arbitrary entry creation. In a worst case scenario, the malicious attack provides ARP flooding messages, which causes a huge amount of useless new entries to remove or overwrite not only the least useful entries but also other useful entries in table Tᵢₙ (almost all entries in table Tᵢₙ are removed or overwritten). Please note that the malicious attack can only affect the table Tᵢₙ; the other tables (e.g. Tₒᵤₜ) still operate normally since the table Tᵢₙ is prioritized to be first referenced in response to ARP message receipt. In other words, even if communication device 10 continuously receives malicious ARP flooding messages, overwriting of entries in other tables (e.g. Tₒᵤₜ) is prevented. Processor 11 prevents entry creation to table Tᵢₙ until the communication device receives an ARP message destined thereto, and no matching entry of which is found in the ARP cache. Time information stored in the other information field of each entry may be utilized to determine the age of the entry and further to locate the least useful entry.

When the ARP message is not destined to communication device 10 (no in step S16), processor 11 discards the ARP message (step S20). Processor 11 may identify the target protocol address in the frame header (i.e. the L2 header) of the ARP message to determine if the ARP message is destined to communication device 10. If the target protocol address in the frame header of the ARP message is the protocol address of communication device 10, processor 11 determines that the first message is destined to communication device 10 and responds as previously described.

In some embodiments, note that processor 11 may search table Tᵢₙ for the matching entry prior to table Tₒᵤₜ. Communication device 10 also performs ARP cache operations when preparing to send a packet. Additionally, an example of ARP message reception is provided in the following.

Taking IP address and MAC address as examples, assume that communication device 10 receives an ARP message, whose source IP and MAC addresses are 172.16.0.2 and 00.01.22.33.E3.98, respectively. After receiving the ARP message (step S2), processor 11 searches whether there is a matching entry (whose IP address is equal to 172.16.0.2) in any ARP table (steps S4 and S10). Preferably, processor 11 looks up table Tₒᵤₜ first rather than table Tᵢₙ. Various cases of searching result are provided in the following:
Case 1: Processor 11 finds there is a matching entry in table Tₒᵤₜ (yes in step S6). Table Tₒᵤₜ is shown in the following.

TABLE Tₒᵤₜ

| | | Other |
|---|---|---|
| IP address | MAC address | information |
| 172.16.0.2 | 00.01.45.86.23.8F | . . . |
| . . . | . . . | . . . |

After finding the matching entry in table Tₒᵤₜ, processor 11 updates the MAC address of the matching entry from 00.01.45.86.23.8F to 00.01.22.33.E3.98, the MAC address of the ARP message (step S8). The modified Table Tₒᵤₜ is shown in the following.

TABLE Tₒᵤₜ
(matching entry updated)

| IP address | MAC address | Other information |
|---|---|---|
| 172.16.0.2 | 00.01.22.33.E3.98 | . . . |
| . . . | . . . | . . . |

Case 2: Processor 11 finds there is a matching entry in table Tᵢₙ (yes in step S12). Table Tᵢₙ is shown in the following.

TABLE Tᵢₙ

| IP address | MAC address | Other information |
|---|---|---|
| 172.16.0.2 | 00.01.02.35.63.7E | . . . |
| . . . | . . . | . . . |

After finding the matching entry in table Tᵢₙ, processor 11 updates the MAC address of the matching entry from 00.01.02.35.63.7E to 00.01.22.33.E3.98, the MAC address of the ARP message (step S14). The modified Table Tᵢₙ is shown in the following.

TABLE Tᵢₙ
(matching entry updated)

| IP address | MAC address | Other information |
|---|---|---|
| 172.16.0.2 | 00.01.22.33.E3.98 | . . . |
| . . . | . . . | . . . |

Case 3: Processor 11 can not find a matching entry in any table (no in step S12). Tables Tᵢₙ and Tₒᵤₜ are shown in the following.

TABLE Tᵢₙ

| IP address | MAC address | Other information |
|---|---|---|
| 172.16.0.1 | 00.03.45.86.23.5F | . . . |
| . . . | . . . | . . . |

TABLE Tₒᵤₜ

| IP address | MAC address | Other information |
|---|---|---|
| 172.16.0.3 | 00.53.47.89.27.5A | . . . |
| . . . | . . . | . . . |

If the ARP message is destined (no in step S16), processor 11 does nothing to any ARP table (S20). Otherwise (yes in step S16), processor 11 adds a new entry to table Tᵢₙ. The IP and MAC addresses of the new entry are 172.16.0.2 and 00.01.22.33.E3.98, the same as those of the ARP message (step S18). If table Tᵢₙ is already full, the least useful entry therein may be removed or overwritten by the new entry. The modified Table Tᵢₙ is shown in the following.

TABLE Tᵢₙ
(matching entry added)

| IP address | MAC address | Other information |
|---|---|---|
| 172.16.0.1 | 00.03.45.86.23.5F | . . . |
| 172.16.0.2 | 00.01.22.33.E3.98 | . . . |

### 4. FRAME TRANSMISSION

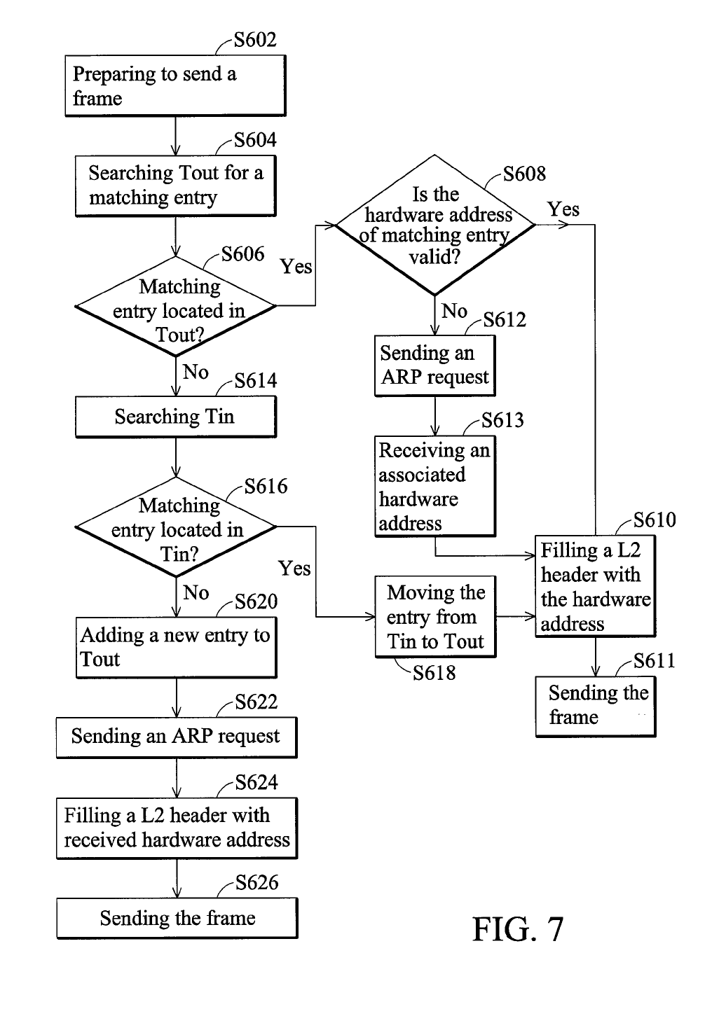

Before communication device 10 transmits any frame to a target host which would be the next hop's host, the communication device 10 must obtain the protocol address (e.g. IP address) and hardware address (e.g. MAC address) of the target host. Generally, the protocol address of the target host is already known by the communication device 10 and the hardware address of the target host must be further searched in the ARP table of the communication device 10. With reference to FIG. 7, when communication device 10 is to send a frame (step S602), Processor 11 first searches table Tₒᵤₜ for a matching entry of the frame (step S604). The matching entry is an entry whose protocol address is the same as that of the target host. If a matching entry is found in Tₒᵤₜ (step S606), processor 11 further checks whether the hardware address of the matching entry is valid before filling the outgoing frame with the hardware address of the matching entry (step S608).

If the hardware address of the matching entry is valid (yes in step S608), processor 11 fills the header of outgoing frame with the matching entry's hardware address (step S610), and transmits the frame through NIU 15 (step S611). Otherwise (no in step S608), NIU 15 transmits an ARP request to acquire the target host's hardware address (step S612). Upon receipt of ARP reply carrying the hardware address, processor 11 accordingly updates the matching entry's hardware address (step S613) and fills the header of outgoing frame with the matching entry's hardware address (step S615). Finally, NIU 15 transmits the frame (step S611).

When no matching entry of the frame is located in table Tₒᵤₜ, processor 11 searches another table Tᵢₙ for such a matching entry of the frame (step S614). Processor 11 determines if such a matching entry exist in Tᵢₙ (step S616). If so, processor 11 moves the matching entry of the frame from Tᵢₙ to Tₒᵤₜ (step S618) and fills the header of outgoing frame with the matching entry's hardware address (step S610). Thus, the matching entry is moved to the table of higher precedence and prevented from being overwritten by incoming ARP messages. After filling in the hardware address (step S610), NIU 15 transmits the frame (S611). If table Tᵢₙ is fall, the least useful entry therein may be removed or overwritten by the matching entry of the frame. Alternatively, the capacity of Tᵢₙ can be enlarged for accommodating the matching entry.

When no matching entry of the frame exists in the ARP cache (no in step S616), processor 11 adds a new entry to table Tₒᵤₜ (step S620), fills a protocol address field of the new entry with the protocol address of the target host, and directs NIU 15 to transmit an ARP request to acquire a hardware address associated with the protocol address of the target host (step S622). Upon receipt of ARP reply carrying the hardware address associated with the protocol address of the target host, processor 11 accordingly fills a hardware address field of the new entry and the header of the frame with the retrieved hardware address (step S624) and directs NIU 15 to transmit the frame (step S626). An example of frame transmission is provided in the following.

Still Taking IP address and MAC address as examples, assume that communication device 10 wants to send frames to a target host, whose IP address is 172.16.0.35 and MAC address is unknown. Before transmitting, processor 11 searches whether there is a matching entry (whose IP address is equal to 172.16.0.35) in any ARP table (steps S604 and S614) to found out the target host's MAC address. Preferably, processor 11 looks up table Tₒᵤₜ first rather than table Tᵢₙ. Various cases of searching result are provided in the following:
Case 1: Processor 11 finds a matching entry in table Tₒᵤₜ (yes in step S606). Table Tₒᵤₜ is shown in the following.

TABLE Tₒᵤₜ

| IP address | MAC address | Other information |
|---|---|---|
| 172.16.0.35 | 00.08.45.86.23.8F | . . . |
| . . . | . . . | . . . |

If the MAC address of the matching entry is valid (e.g. 00.08.45.86.23.8F) (yes in step S608), communication device 10 fills the frame's MAC address field with the valid value 00.08.45.86.23.8F and transmits the frame (steps S610 and S611). Otherwise (no in step S608), processor sends an ARP request for the target host's MAC address to update the matching entry's MAC address (step S613).
Case 2: Processor 11 finds there is a matching entry in table Tᵢₙ (yes in step S616). Table Tᵢₙ is shown in the following.

TABLE Tᵢₙ

| IP address | MAC address | Other information |
|---|---|---|
| 172.16.0.35 | 01.23.46.87.23.5C | . . . |
| . . . | . . . | . . . |

Similarly, communication device 10 fills the frame's MAC address field with the matching entry's MAC address (e.g. 01.23.46.87.23.5C) and transmits the frame (steps S610 and S611). The key difference with case 1 is that the matching entry further moves form table Tᵢₙ to table Tₒᵤₜ (step S618).

TABLE Tᵢₙ
(matching entry moved)

| IP address | MAC address | Other information |
|---|---|---|
| . . . | . . . | . . . |

Case 3: Processor 11 can not find a matching entry in any table (no in step S616). Tables Tᵢₙ and Tₒᵤₜ are shown in the following.

TABLE Tᵢₙ

| IP address | MAC address | Other information |
|---|---|---|
| 172.16.0.33 | 00.03.45.86.23.5F | . . . |
| . . . | . . . | . . . |

TABLE Tₒᵤₜ

| IP address | MAC address | Other information |
|---|---|---|
| 172.16.0.28 | 00.53.47.89.27.5A | . . . |
| . . . | . . . | . . . |

Processor 11 adds a new entry in table Tₒᵤₜ and fills its IP address with 172.16.0.35, and sends an ARP request to fills its MAC address (steps S620, S622 and S624). After the IP and MAC addresses of the frame are filled according to the responded ARP reply, communication device 10 sends the frame (step S626). The modified Table Tₒᵤₜ is shown in the following.

TABLE Tₒᵤₜ
(matching entry added)

| IP address | MAC address | Other information |
|---|---|---|
| 172.16.0.28 | 00.53.47.89.27.5A | . . . |
| 172.16.0.35 | 00.01.22.33.E3.98 | . . . |

### 5. CONCLUSION

Implementation of entry movement from table Tᵢₙ to table Tₒᵤₜ may be different in the various ARP cache configurations. Specifically, when tables Tₒᵤₜ and Tᵢₙ are respectively located in different areas of ARP cache 18, processor 11 may generate a copy of the matching entry of the frame in Tₒᵤₜ and delete the matching entry of the frame in Tᵢₙ. When classification of the matching entry of the frame is identified based on an associated class ID, processor 11 may modify the class ID to implement the movement of the matching entry of the frame from Tᵢₙ to Tₒᵤₜ. According to the ARP management method, unsolicited ARP entry destined to the target host are stored in Tᵢₙ, and moved to Tₒᵤₜ when referenced for frame transmission. Thus, malicious ARP flooding messages are prevented from overwriting recently referenced ARP entries in Tₒᵤₜ. Table 2 in the following summarizes operations of communication device 10.

TABLE 2

| | Search result | | | |
|---|---|---|---|---|
| | | Found in Tₒᵤₜ | | |
| | | Without | | |
| Frame | | hardware | With hardware | |
| Operation | Not found | address | address | Found in Tᵢₙ |
| Frame | 1. Adding a new | 1. Replacing | 1. Filling | 1. Moving the |
| transmission | entry without | the held frame | hardware | located entry |
| | hardware | 2. Sending an | address in the | from Tᵢₙ to Tₒᵤₜ |
| | address to Tₒᵤₜ | ARP request if | header of the | 2. Filling |
| | 2. Holding the | allowed | frame | hardware |
| | frame | | 2. Sending the | address in the |
| | 3. Sending an | | frame | header of the frame |
| | ARP request | | | 3. Sending the frame |

| | | |
|---|---|---|
| ARP | Adding a new | Updating matching ARP entry located in Tₒᵤₜ or Tᵢₙ |
| message | ARP entry to Tᵢₙ if | |
| receipt | the ARP message | |
| | is destine to | |
| | device 10 | |

When NIU 15 receives a request for frame-based communication, processor 11 searches ARP cache 18 for a matching entry corresponding to the frame-based communication and if locating the matching entry, classifies the matching entry into Tᵢₙ or Tₒᵤₜ according to the frame-based communication. For example, when the matching entry is located in Tᵢₙ in response to a request for transmitting a frame, processor 11 classifies the matching entry into Tₒᵤₜ. When the matching entry is located in Tᵢₙ in response to a request for receiving an ARP message, processor 11 does not change classification of the matching entry, thus, the matching entry remains in Tᵢₙ. When the matching entry is located in Tₒᵤₜ in response to a request for receiving an ARP message or transmitting a frame, processor 11 does not change classification of the matching entry.

If no entry corresponding to the frame-based communication has been located, processor 11 creates a corresponding new entry in response to the frame-based communication, and classifies the new entry according to the frame-based communication. When the new entry is created in response to a request for transmitting a frame, processor 11 classifies the entry into Tₒᵤₜ. When the new entry is created in response to a request for receiving an ARP message, processor 11 classifies the entry into Tᵢₙ.

Generally, when NIU 15 receives a request for frame-based communication, processor 11 performs an entry operation on a matching entry in the ARP cache in response to the request and classifies the matching entry into of Tᵢₙ or Tₒᵤₜ according to the entry operation and the frame-based communication.

The ARP management method may be implemented in other devices connected to network 30 and network A 50, such as mobile device 20, computer 22, and router 40.

In conclusion, at least two tables, Tᵢₙ and Tₒᵤₜ, are allocated in an ARP cache, and updatable ARP entries are respectively classified thereto. The number of entries in Tᵢₙ is limited to less than the total number of all the updatable entries of the ARP cache. An ARP entry currently referenced for frame transmission is stored in table Tₒᵤₜ and is first referenced in response to a subsequent frame transmission, thus to improve time efficiency of ARP lookup. Unsolicited ARP entries are stored in table Tᵢₙ, and moved to Tₒᵤₜ once referenced for frame transmission. Thus, malicious ARP flooding messages are prevented from overwriting recently referenced ARP entries in table Tₒᵤₜ.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An address resolution protocol (ARP) cache management method for managing an ARP cache in a communication device, wherein the ARP cache comprising at least one reserved ARP table and at least one unreserved ARP table, each ARP table comprising a plurality of entries, each entry comprising a cache protocol address and a cache hardware address, comprising:
receiving an ARP message, wherein the ARP message comprises a message protocol address and a message hardware address;
looking up at least one of the ARP tables to find an entry whose cache protocol address matches the message protocol address of the received ARP message; and
if no entry is found, creating a new entry in the unreserved ARP table, wherein the new entry contains the message protocol address and the message hardware address, or overwriting an existing entry in the chosen ARP table with the new entry.

2. The method as claimed in claim 1, wherein the step of looking up the ARP tables further comprises:
looking up the reserved ARP table first to determine whether the message-matching entry exists in the reserved ARP table; and
if not, continuing to look up the unreserved ARP table to determine whether the message-matching entry exists in the unreserved ARP table.

3. The method as claimed in claim 1, wherein the step of creating the new entry further comprises respectively filling the cache protocol address and the cache hardware address of the new entry with the message protocol address and the message hardware address included in the ARP message.

4. The method as claimed in claim 1, wherein the step of creating the new entry further comprises preventing entry creation in the reserved table until receipt by the communication device of an ARP message destined thereto.

5. The method as claimed in claim 2, wherein the step of updating the message-matching entry further comprises filling the cache hardware address of the message-matching entry with the message hardware address included in the ARP message.

6. The method as claimed in claim 1, further comprising providing an attribute for each entry, wherein the attribute indicating which ARP table the entry belong to.

7. The method as claimed in claim 1, further comprising:
when the communication device is to transmit a frame to a target host, finding or creating a transmission matching entry in the reserved ARP table, wherein the protocol address in the transmission matching entry of the frame matches the protocol address of the target host of the frame;
filling a transmission protocol address of the target host of the frame with the transmission matching entry's protocol address;
filling a transmission hardware address of the target host of the frame with the transmission matching entry's hardware address; and
transmitting the frame to the target host.

8. The method as claimed in claim 1, wherein different ARP tables are located in different areas of the ARP cache.

9. The method as claimed in claim 7, wherein the step of finding or creating the transmission matching entry further comprises:
if the transmission matching entry of the frame exists in the unreserved table, moving the transmission matching entry of the frame from the unreserved table to another table.

10. A communication device, capable of address resolution protocol (ARP) management, comprising:
an ARP cache comprising:
a plurality of ARP tables, each ARP table comprising:
a plurality of updatable entries, each entry comprising a cache protocol address and a cache hardware address;
a network interface unit for receiving ARP messages or transmitting frames to a target host, wherein each ARP message comprises a message protocol address and a message hardware address, and each frame comprises a transmission protocol address and a transmission hard-ware address; and
a processor comprising:
means for looking up the pluralities of ARP tables to find whether a message-matching entry exists after the network interface unit receives an ARP message;
means for looking up the pluralities of ARP tables to find whether a transmission matching entry exists before the network interface unit transmits a frame;
means for choosing an ARP table for storing new entries; and
means for creating a new entry to overwrite an existing entry in the chosen ARP table if no message-matching entry is found;
wherein the message-matching entry is an entry whose cache protocol address is equal to the message protocol address of the received ARP message, and the protocol address in the transmission matching entry of the frame matches the protocol address of the target host of the frame.

11. The device as claimed in claim 10, wherein the creating means prevents entry creation to the chosen table until receipt by the communication device of an ARP message destined thereto.

12. The device as claimed in claim 10, wherein, one entry belongs to which table is indicated by an attribute associated with the entry.

13. The device as claimed in claim 10, wherein different tables are located in different areas of the ARP cache.

14. The device as claimed in claim 10, wherein, if the transmission matching entry of the frame exists in the chosen table, the processor moves the transmission matching entry of the frame from the chosen table to another table.

15. An address resolution protocol (ARP) cache management method for managing an ARP cache in a communication device, the ARP cache comprising a plurality of ARP tables, each ARP table comprising a plurality of updatable entries, comprising:
performing an entry operation on a first entry in the ARP cache in response to a request for frame-based communication; and
re-classifying the first entry into one of a plurality of ARP tables in the ARP cache according to the entry operation and the frame-based communication.

16. The method as claimed in claim 15, further comprising, when the entry operation comprises creating the first entry, and the frame-based operation comprises receiving an ARP message, classifying the first entry into a first ARP table in the ARP.

17. The method as claimed in claim 15, further comprising, when the entry operation comprises creating the first entry, and the frame-based the operation comprises transmitting a first frame, classifying the first entry into a second ARP table in the ARP cache.

18. The method as claimed in claim 17, further comprising, when a subsequent frame transmission request is received, first referencing to entries in the second ARP table is prior to other tables in the ARP cache in response to the frame transmission request.

19. The method as claimed in claim 17, wherein the ARP cache comprises a first ARP table of entries created in response to ARP message receipt and the second ARP table of entries created in response to frame transmission, further comprising, when the entry operation comprises locating the first entry in the first ARP table, and the frame-based the operation comprises transmitting a first frame, classifying the first entry into the second ARP table.

20. The method as claimed in claim 19, wherein the first and second ARP tables are respectively located in different areas of the ARP cache.

21. A communication device, capable of address resolution protocol (ARP) management, comprising:
an ARP cache comprising:
a plurality of ARP tables, each ARP table comprising:
a plurality of updatable entries, each entry comprising a cache protocol address and a cache hardware address;
a network interface unit receiving a request for frame-based communication; and
a processor performing an entry operation on an entry in the ARP cache in response to the request and classifying the entry into one of a plurality of ARP tables in the ARP cache according to the entry operation and the frame-based communication.

22. The device as claimed in claim 21, further comprising, when the entry operation comprises creating the first entry, and the frame-based operation comprises receiving an ARP message, the processor classifies the first entry into a first ARP table in the ARP cache.

23. The device as claimed in claim 21, wherein, when the entry operation comprises creating the first entry, and the frame-based the operation comprises transmitting a first frame, the processor classifies the first entry into a second ARP table in the ARP cache.

24. The device as claimed in claim 23, wherein, when a subsequent frame transmission request is received, the processor first references entries in the second ARP table prior to other ARP tables in the ARP cache in response to the frame transmission request.

25. The device as claimed in claim 21, wherein the ARP cache comprises a first ARP table of entries created in response to ARP message receipt and a second ARP table of entries created in response to frame transmission, when the entry operation comprises locating the first entry in the first ARP table, and the frame-based the operation comprises-transmitting a first frame, the processor classifies the first entry into the second ARP table.

26. An address resolution protocol (ARP) cache management method for managing an ARP cache in a communication device, wherein the ARP cache comprises a plurality of ARP tables each comprising updatable entries, comprising:
when the communication device receives an ARP message, determining if the ARP cache comprises a message-matching entry comprising a cache protocol address matching the sender protocol address included in the received ARP message; and
if not, and when the ARP message is destined to the communication device, restricting a new entry to be created in an unreserved ARP table to respond to the ARP message.

27. The method as claimed in claim 26, further comprising respectively filling a protocol address field and a hardware address field of the new entry with the sender protocol address and the sender hardware address included in the ARP message.

28. The method as claimed in claim 26, further comprising preventing entry creation in the unreserved ARP table until receipt by the communication device of an ARP message destined thereto, and no message-matching entry of the ARP message is found in the ARP cache.

29. The method as claimed in claim 26, further comprising, when the ARP cache comprises the message-matching entry comprising the sender protocol address included in the received ARP message, updating the matching entry utilizing the ARP message.

30. The method as claimed in claim 29, wherein the entry update comprises filling a hardware address field of the message-matching entry with the sender hardware address included in the ARP message.

31. The method as claimed in claim 26, wherein the unreserved ARP table is located in an area of the ARP cache.

32. The method as claimed in claim 26, wherein, whether one entry belongs to the unreserved ARP table is indicated by an attribute associated with the entry.

33. An address resolution protocol (ARP) cache management method for managing an ARP cache in a communication device, wherein the ARP cache comprises a reserved and an unreserved ARP table, each comprising updatable entries, comprising:
when the communication device is to send a frame, first searching the reserved ARP table to locate a transmission matching entry of the frame, wherein the cache protocol address in the transmission matching entry matches the protocol address of a next hop of the frame;
when no transmission matching entry exists in the reserved ARP table, searching the unreserved ARP table to locate a transmission matching entry; and
when no transmission matching entry exists in the ARP cache, restricting a new entry to be created in the reserved ARP table.

34. The method as claimed in claim 33, further comprising filling a protocol address field of the second new entry with the protocol address of the next hop of the first frame.

35. The method as claimed in claim 33, wherein entries in the unreserved ARP table are created in response to ARP message receipt, and entries in the reserved ARP table are created in response to frame transmission.

36. An address resolution protocol (ARP) cache management method for managing an ARP cache in a communication device, wherein the ARP cache comprises updatable entries, comprising:
when the communication device receives an ARP message, determining if the ARP cache comprises a message-matching entry comprising a cache protocol address matching the sender protocol address included in the received ARP message; and
when the ARP cache has no such matching entry, and the ARP message is destined to the communication device, creating a new entry in ARP cache to respond the ARP message reception and restricting the number of created entries in response to ARP message reception to be less than the total number of all the updatable entries of the ARP cache.

37. An address resolution protocol (ARP) cache management method for managing an ARP cache in a communication device, wherein the ARP cache comprises updatable entries, comprising:
creating new entries in ARP cache to respond ARP message reception when the condition of entry creation is satisfied; and
restricting the number of created entries in response to ARP message reception to be less than the total number of all the updatable entries of the ARP cache.
